(19) United States
(12) Patent Application Publication
(10) Pub. No.: US 2006/0244231 A1
(43) Pub. Date: Nov. 2, 2006

(54) Walking scooter

(76) Inventor: Carol Ann Rogers, Bush, LA (US)

Correspondence Address: Carol Rogers, 81283 Bright Penny Road, Bush, LA, 70431, US

(21) Appl. No.: 11/408,376

(22) Filed: Apr. 22, 2006

Related U.S. Application Data
(60) Provisional application No. 60/675,743, filed on Apr. 29, 2005.

(51) Int. Cl. B62B 7/00

(52) U.S. Cl. 280/87.051

(57) ABSTRACT

The Walking Scooter is a device that provides mobility for someone who cannot stand in a full weight bearing position because of pain, weakness, or instability. You straddle the device, resting your weight on the seat while maintaining an upright position. This is the main difference from other walking aids. The scooter supports your weight and puts you in a position to propel it by walking. It provides another level of mobility prior to requiring a wheelchair.

### CROSS REFERENCE TO RELATED APPLICATIONS

I filed a provisional application on Apr. 29, 2005 and received an application Ser. No. 60/675,743.

### STATEMENT REGARDUNG FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

This is a land vehicle with wheels that supports the occupant and is pushed along by contact of the occupant's feet with the ground. It is a wheeled mobility device that is propelled by an occupant who is supported in a near standing position. Other devices that assist disabled persons to walk require the person to support their own weight. Some devices allow the person to rest on a bench seat in between the periods of walking. None allow the person to walk in a non-weight bearing position. This device allows the occupant to straddle the seat, rest their weight on the seat, and remain upright in a near standing position. They propel the device by using a walking modality to push the device in any direction while their weight is supported on the seat.

### SUMMARY OF INVENTION

The Walking Scooter is a mobility device. It is designed to help those disabled persons who have the use of their legs yet find it difficult to use a conventional walker. Conventional walkers are difficult to use by people who experience pain, weakness, or instability in their legs, knees, or feet when they stand in a full weight-bearing position. The Walking Scooter allows the person to support their weight by straddling the scooter. In an upright, near standing position they use their legs and feet to propel the scooter by pushing it in any direction. The scooter supports their weight and takes the pressure from their legs, knees, or feet. The scooter is designed to be small enough to manipulate in small areas. It is designed with a straight, flat front so that it can be maneuvered close to counter tops in order to perform daily tasks. The ball bearing, swivel wheels allow it to be moved easily in any direction. The size of the wheels allows you to use it on a variety of surfaces. The purpose of the walking scooter is to provide another level of mobility. It is a transition between a conventional walker and a wheelchair.

### DESCRIPTION OF THE VIEW OF THE DRAWING

There are two drawings that depict views of the walking scooter. They both illustrate the appearance of the scooter, the dimensions of the scooter, the straddle seat, the adjustable legs, the adjustable seat, and the ball bearing, swivel wheels.

FIG. 1 depicts the view of the adult model.

FIG. 2 depicts the view of the children's model.

### DETAILED DESCRIPTION OF THE INVENTION

The Walking Scooter is designed to provide mobility for those disabled persons who have the use of their legs, yet find it difficult to use a conventional walker. They may find it difficult to use a conventional walker because they experience pain, weakness, or instability in their legs, knees, or feet when they stand up and support their full weight. This is the main difference that distinguishes the walking scooter from other conventional walkers that are on the market. None of the others support the person's weight as they walk. The Walking Scooter supports your weight taking any pressure off of the legs, knees, and feet. For example, elderly persons who can walk but are unstable or weak can use the scooter to support their weight providing an opportunity to continue to remain mobile. Children with debilitating illnesses affecting the strength of their legs or feet can become more active by using the Walking Scooter.

The purpose of the invention is to provide mobility to those who are having difficulty using a conventional walker yet who do not need to be confined to a wheelchair. It also provides the opportunity to maintain muscle strength because you continue to use your legs. It offers another level of mobility prior to being confined to a wheelchair.

The Walking Scooter is a walking aid that is designed with a seat that is straddled. You rest your weight on the seat while maintaining an upright position at a near standing height. Then use your legs and feet to walk and scoot in any direction.

The Walking Scooter is designed with a narrow, long seat that is supported on four legs for stability. The legs are mounted on swivel, ball bearing wheels to allow mobility in any and all directions. The size and width of the wheels allow for easy mobility on a variety of surfaces. There is a handle bar with handle grips in the front of the scooter for support and stability. The front is flat to allow the person to stand next to kitchen countertops or bathroom vanities to perform daily tasks. The front is also low enough so as not to interfere with tasks performed at a counter top. The legs and seat of the Walking Scooter are adjustable to accommodate each individual's height. It is short in length and narrow in width to allow use in limited spaces. It is also small in size and light in weight to make it easy to transport in the trunk or on the back seat of a car.

There will be two sizes—one size for adults and one size for children. Each size will have adjustable legs and an adjustable seat to adjust for the appropriate height. The appropriate height is measured from the person's crotch to the floor or by using the length of the pants inseam. At this height the person will then be able to rest his/her weight on the seat in a near standing position with their feet touching the ground surface. The seat will be padded for comfort.

The Walking Scooter as shown in figure one is the adult size. The front panel is fourteen inches wide from side to side. The interior cross bars measure twelve inches wide. It is nineteen inches long with an adjustable height. The base height of the frame from the horizontal bar with the seat to the place of attachment to the wheels is 20½ inches. The height of the front of the unit from the handlebars to the point of attachment to the wheels is 30 inches. The seat is three inches wide and mounted on an adjustable hinge. The swivel, ball-bearing wheels are five inches in diameter and an inch and a fourth in width. The frame of the scooter is made of aluminum tubing. Telescoping aluminum tubing is used on the front legs with drilled holes for height adjustment. The rear legs are also telescoping with aluminum rods used for strength. The rods are bent to shape and also have drilled holes for height adjustment. The seven and one half inches between the rear wheels allow the wheels to turn in all directions without interfering with each other. The swivel, stem, ball bearing wheels are inserted into inserts at the base of the legs. The front wheels have mounted brakes.

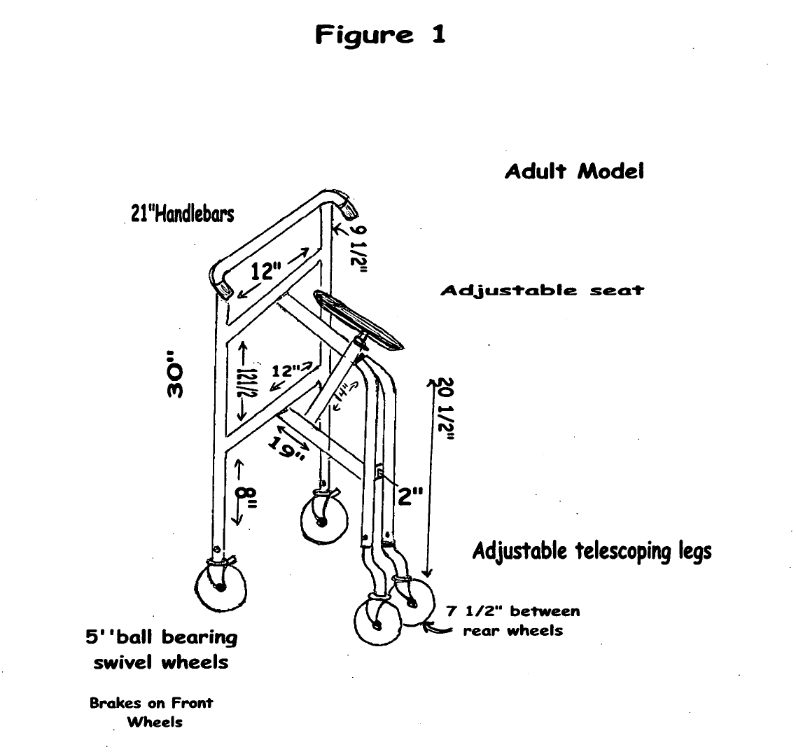

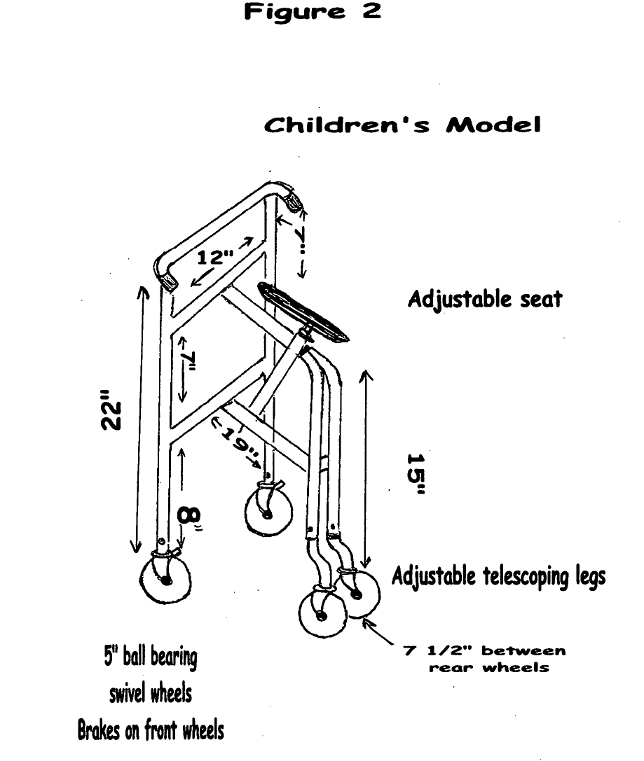

The drawing in FIG. 2 illustrates the size for children. It is made in the same way as the adult model in FIG. 1 except the dimensions for the height of the frame are smaller to accommodate the child. The base height of the frame from the horizontal bar with the seat to the attachment point of the wheels is 15 inches. The height of the front panel from the handlebars to the point of attachment to the wheels is 22 inches. The length and width of the unit is the same as that of the adult size. This width and length give stability to the unit.

The goal of this invention is to provide mobility for those who cannot support their full weight while walking. It provides another level of mobility.

1. I claim that the invention is the structure of the walking aid:
It allows the person to straddle the walking aid in a near standing position, taking the weight off of the legs, knees, and feet, and then allowing the person to use a walking modality to propel it.
It's ball bearing, swivel wheels provide movement in any direction and on a variety of surfaces.
Its compact size and its shape make it maneuverable in small areas.
These features of the structure introduce a new level of mobility.
